(19) United States
(12) Patent Application Publication
(10) Pub. No.: US 2012/0054043 A1
(43) Pub. Date: Mar. 1, 2012

(54) Access Control for User-Related Data

(76) Inventors: Anurag Agarwal, Sunnyvale, CA (US); Rajas Moonka, San Ramon, CA (US); Raghava Hassan Nanjunda Swamy, Sunnyvale, CA (US); Oren E. Zamir, Los Altos, CA (US); Vadim Furman, San Jose, CA (US)

(21) Appl. No.: 13/222,507

(22) Filed: Aug. 31, 2011

Related U.S. Application Data
(60) Provisional application No. 61/379,041, filed on Sep. 1, 2010.

(51) Int. Cl. G06Q 30/06; G06Q 30/08

(52) U.S. Cl. 705/14.71; 705/26.1; 705/14.69

(57) ABSTRACT

The subject matter of this specification can be embodied in, among other things, a computer-implemented method for controlling access to user-related data including electronically registering a plurality of data providers with a computer-implemented data exchange. The method further includes electronically registering a plurality of data buyers with the computer-implemented data exchange. The method further includes mediating a data sharing arrangement between one or more of the data buyers and one or more of the data providers, the data sharing arrangement defining prices and permitted uses of data provided by the one or more data providers to the one or more data buyers. The method further includes enforcing, on behalf of the one or more data providers, one or more restrictions imposed by the data sharing arrangement on the one or more data buyers.

### CROSS-REFERENCE TO RELATED APPLICATIONS

This application claims priority to U.S. Provisional Application Ser. No. 61/379,041, filed on Sep. 1, 2010. The content of U.S. Provisional Patent Application No. 61/379,041 is hereby incorporated by reference into this application as if set forth herein in full.

### TECHNICAL FIELD

This document relates to information exchange.

### BACKGROUND

The number of services available over the internet grows every day. The most noticeable of these services are aimed at consumers—web search, maps, hosted documents and spreadsheet, location-based services, and the like.

Less noticed are web-based services that are available for businesses. One prominent service is on-line targeted advertising, where a business can submit an ad, some targeting keywords, and a bid, and can have its ad shown to web users in situations where the keywords are relevant. This form of advertising can be very simple, with a small business logging in and running a handful of ads. It can also be extremely complex, with large ad agencies or advertisers running hundreds of campaigns with thousands of ads, selecting particular web sites to run their ads, and fine-tuning a number of parameters to maximize the effectiveness of the ad campaigns.

Certain companies generate data as part of their operations and certain other companies may have a great need for that data. For example, an automotive web site may be able to generate data that indicates which of its visitors are likely to buy a car in the next six months. This information—that the consumer is actually ready to spend, and not just window shopping—can be incredibly valuable to a seller of automobiles. It can in turn be valuable to a company, such as an on-line publisher, that sells ad space to sellers of automobiles. In addition, some advertisers, such as the seller of automobiles, may find targeting such users beneficial and may be willing to pay extra for the data. For example, the advertiser could determine from the automotive website whether a consumer is interested in big cars or small cars, and the advertiser could target ads appropriately.

### SUMMARY

In general, this document describes controlling access to user-related data. The user-related data can be used, for example, in advertising. In one example, the user-related data can be priced for real-time-bidders which have access to the user-related data when placing bids, e.g., for an advertising slot. Access to the user-related data is controlled by one or more terms and restrictions that can be specified by an entity that provides or owns the user-related data.

In one aspect, a computer-implemented method for controlling access to user-related data includes electronically registering a plurality of data providers with a computer-implemented data exchange. The method further includes electronically registering a plurality of data buyers with the computer-implemented data exchange. The method further includes mediating a data sharing arrangement between one or more of the data buyers and one or more of the data providers, the data sharing arrangement defining prices and permitted uses of data provided by the one or more data providers to the one or more data buyers. The method further includes enforcing, on behalf of the one or more data providers, one or more restrictions imposed by the data sharing arrangement on the one or more data buyers.

Implementations can include any, all, or none of the following features. The restrictions include limiting the data sharing arrangement to a particular number of data buyers. The restrictions include limiting the data sharing arrangement to a particular amount of time. The restrictions include preventing specific data buyers from accessing the data. The restrictions include allowing specific data buyers to access the data. The restrictions include verifying that the data includes information for at least a particular minimum number of users. The restrictions include limiting the data to use in bidding for an advertisement placement. The restrictions include one or more filtering criteria. The method includes providing lists of identifiers to each of the plurality of data providers. The method includes encrypting the identifiers in each of the lists. The method includes correlating data from a first one of the one or more data providers with a second one of the data providers using the encrypted identifiers from the lists for the first and second ones of the one or more data providers. The computer-implemented data exchange collects data for at least one of the one or more data providers. At least one of the one or more data providers collect a portion the data. The method includes providing a portion of the data to the one or more data buyers during purchases of advertisement placements. The restrictions include limiting a number of advertisement impressions from one or more of the data buyers for the portion of the data. The method includes managing syndication permissions for the one or more data buyers to share the data. Managing the syndication permissions includes permitting the one or more data buyers to share the data in its original form. Managing the syndication permissions includes permitting the one or more data buyers to aggregate the data with additional data. Managing the syndication permissions includes revoking the syndication permissions. The method includes determining one or more additional data buyers with which the data has been shared, and wherein managing the syndication permissions includes applying the syndication permissions to the additional data buyers. The method includes receiving an indication of one or more logical operations from the one or more data buyers that filter the data.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram that shows an example of system for controlling access to and pricing user-related data.

FIG. 2 is a block diagram that shows an example of a data exchange system.

FIG. 3A is a flow chart that shows an example of a process for controlling access to user-related data.

FIGS. 3B-E are flow charts that show examples of processes for pricing user-related data from a data provider.

FIGS. 3F-G are flow charts that show examples of processes for pricing user-related data from multiple data providers.

FIGS. 4A-E are flow charts that show examples of processes for controlling access to and pricing user-related data.

FIG. 5 is a schematic diagram that shows an example of a computing system.

### DETAILED DESCRIPTION

This document describes systems and techniques for controlling access to and pricing user-related data. In general, one or more data provider systems share user-related data with a data exchange system. The data exchange system subsequently provides the user-related data to one or more data consumer (e.g., data buyer) systems, such as advertiser systems. The data exchange system controls how the data buyers access the user-related data. In some implementations, the data providers specify one or more restrictions for controlling access to the user-related data. The data exchange system can debit the data consumers that receive or use the user-related data and credit the data providers that provided the user-related data.

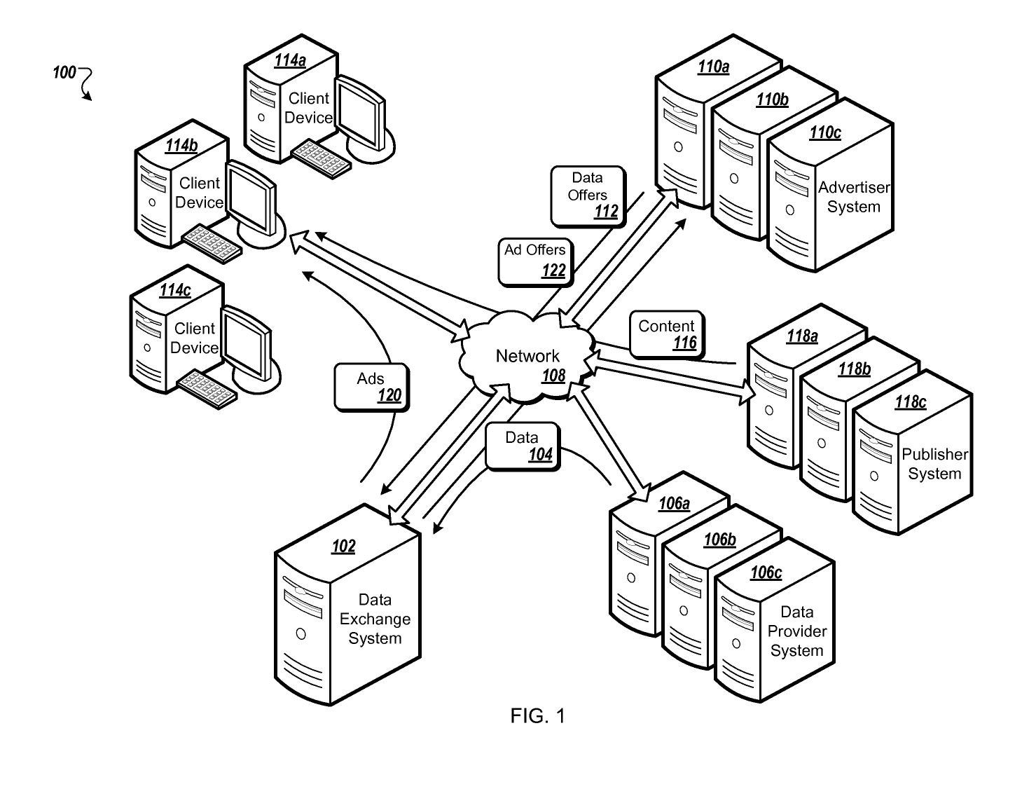

FIG. 1 is a schematic diagram that shows an example of a system 100 for controlling access to and pricing user-related data. The system 100 includes a data exchange system 102 that receives a plurality of user-related data 104, for example, from one or more data provider systems 106a-c through a network 108. The system 100 also includes one or more consumers of the user-related data (e.g., one or more advertiser systems 110a-c) that send one or more offers 112 to the data exchange system 102 to access at least a portion of the user-related data 104. The data exchange system 102 selects one or more of the advertiser systems 110a-c and provides (or makes available) the portion of the user-related data 104 to the selected advertiser systems. The data exchange system 102 debits accounts of one or more of the advertiser systems 110a-c that received the portion of the user-related data 104. In addition, the data exchange system 102 credits accounts of one or more of the data provider systems 106a-c that provide the portion of the user-related data 104.

The user-related data 104 is information associated with one or more persons. For example, the user-related data 104 can include personal preferences of a particular person, a history of web sites viewed by the person, or a history of advertisements clicked on or selected by the person. In some implementations, the user-related data 104 does not include information capable of determining corresponding identities of the persons associated with the user-related data 104. For example, the user-related data 104 can exclude names of the persons, postal addresses of the persons, or other information that can be linked to the identities of the persons.

The data exchange system 102 and/or the data provider system 106a-c can, in some implementations, allow a person represented by the user-related data to opt out of user-related data collection or opt of certain types of data collection (e.g., web site history or advertisement clicks). For example, one or more of the data provider systems 106a-c may use its own identifiers for user-related data and one or more may use an identifier (which may be encrypted) provided by the data exchange system 102. In the case where a person opts out of data collection through the data exchange system 102 and a data provider uses its own identifiers, the data exchange system 102 can inform the data provider that the person has opted out of data collection. The data exchange system 102 can inform the data providers of the opt out, for example, using an application program interface (API), e.g., during an API call requesting a transfer of data to the data exchange system 102 or a separate API call.

In some implementations, at least a portion of the user-related data 104 can be gathered offline and then entered/or otherwise provided to one or more of the data provider systems 106a-c and/or the data exchange system 102. For example, user-related data can be written by a person on a questionnaire and then entered into a data provider system by an administrative user.

Alternatively or in addition, at least a portion of the user-related data 104 can be gathered (e.g., automatically) by the data provider systems 106a-c and/or the data exchange system 102. For example, web page requests and other actions, such as clicks on or selections of content (e.g., hyperlinks, images, videos, or advertisements) can be recorded and associated with a unique identifier. The identifier can be used as an anonymous representation of the person associated with the recorded data. In some implementations, the identifier and/or user-related data for a person can be stored in a cookie at a client computing device operated by the person. The client computing device can then provide the cookie to one or more of the data provider systems 106a-c and/or the data exchange system 102, for example, in a web form submission or web page request.

In some implementations, a data provider system, which can also be a publisher system, sends content to a client computing device. The content can include an inline frame with a source web address of the data exchange system 102 for an advertisement slot or a pixel (e.g., a small web page that is not intended to be seen by the person at the client computing device). The small page can be, for example, an inline frame that is one pixel wide by one pixel in height. The data provider system can pass user-related data to the data exchange system 102 through parameters in the source address of the inline frame.

For example, the Uniform Resource Locator (URL) in the source address of the inline frame can include the following web address and URL parameters: “http://dataexchange.example.com?user_id=123456789&user_type=car_buyer.” This URL passes an identifier of the person and a key-value pair indicating that the user is of a type that intends to purchase a car. The hyperlink can include other parameters, such as an identifier of the data provider and/or additional key-value pairs for other user-related data. In some implementations, the data exchange system 102 uses the identifier of the data provider in the URL of the inline frame to attribute the user-related data in the URL to the data provider.

The system 100 further includes one or more client computing devices 114a-c that receive a plurality of content 116 from one or more publisher systems 118a-c. For example, the client computing device 114a can receive a news web page from the publisher system 118a, the client computing device 114b can receive a video from the publisher system 118b, and the client computing device 114c can receive a search results web page from the publisher system 118c. In some implementations, one or more of the publisher systems 118a-c can also be data providers and/or advertisers, and one or more of the data provider systems 106a-c can also be advertisers.

The content 116 provided by the publisher systems 118a-c includes one or more content slots (e.g., advertisement slots). An advertisement slot is a space in the content 116 that is available for the placement of an advertisement. For example, a web page can include a side bar or other predefined location with one or more slots for insertion of advertisements. In another example, an advertisement can be inserted at the beginning of or at some other position in a video or audio presentation.

The publisher systems 118a-c provide information to the data exchange system 102 that describes the available advertisement slots. The data exchange system 102 then identifies one or more advertisements 120 to be placed in the advertisement slots. Alternatively, a system separate from the data exchange system 102 can receive the advertisement slot information and identify the advertisements 120 to be placed in the advertisement slots.

In some implementations, the data exchange system 102 receives one or more offers 122 from the advertiser systems 110a-c to place advertisements in the available advertisement slots. In some implementations, the advertiser systems that received the portion of the user-related data 104 base their offers for the advertisement placement on information in the portion of the user-related data 104. For example, an advertiser may specify one or more criteria for placing advertisements. The criteria can include, for example, requiring that the user-related data contains an indication of a particular personal preference or a particular demographic characteristic. In another example, an advertiser may choose to make a higher offer for an advertisement placement than the advertiser would otherwise make if the user-related data associated with the person indicates a particular likelihood that the person will make a certain type of purchase soon.

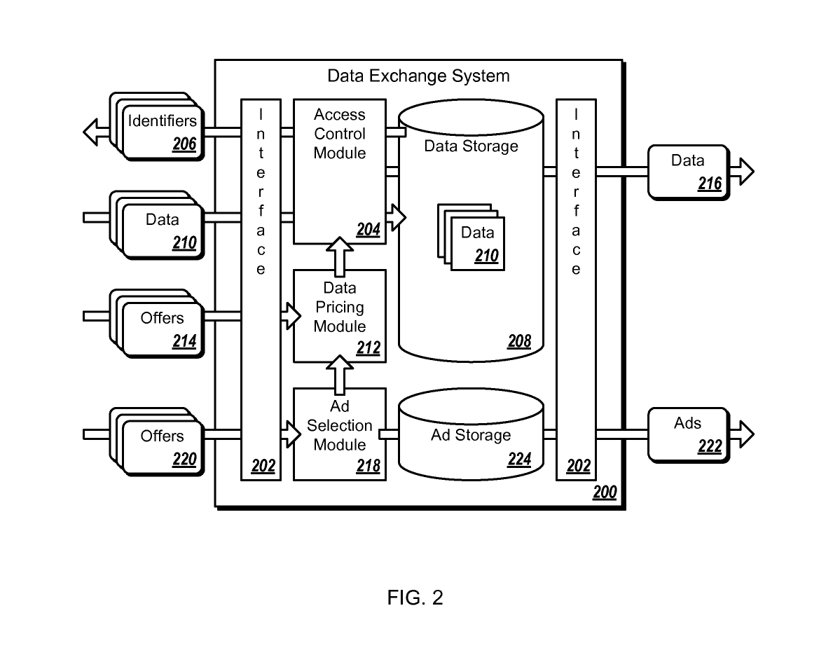

FIG. 2 is a block diagram that shows an example of a data exchange system 200. The data exchange system 200 includes one or more interfaces 202 for communicating with other systems, such as data provider systems, advertiser systems, and client computing devices. For example, the data exchange system 200 can include an access control module 204 that provides one or more identifiers 206 to data provider systems that have contracted with the data exchange system 200 to share user-related data. The access control module 204 can associate each of the identifiers 206 with a particular person.

In some implementations, two or more of the identifiers 206 represent the same person. For example, the access control module 204 can provide a first one of the identifiers 206 to a first data provider and a second one of the identifiers 206 to a second data provider, where the first and second identifiers represent the same person. In some implementations, the access control module 204 internally maintains an identifier that represents the person, and associates the first and second identifiers with the internally maintained identifier.

For example, the access control module 204 can perform an encryption or hashing operation on the internally maintained identifier to generate the first and second identifiers. The encryption can be based on an algorithm such that the first and second identifiers can be regenerated again from the internally maintained identifier or the first and/or second identifier can be decrypted to determine the internally maintained identifier. Alternatively, the access control module 204 can generate the first and second identifiers (e.g., randomly) and store the generated identifiers along with the internally maintained identifier in a data storage 208.

The relationship between the first, second, and internally maintained identifiers allows the data exchange system 200 to join multiple user-related data 210 from multiple data providers together for a particular person. For example, the first data provider using the first identifier can provide relatively static user-related data, such as personal preferences or demographic characteristics of the person, while the second data provider using the second identifier can provide dynamic user-related data, such as web form data and clicks or other actions performed on a web page. The access control module 204 can then join, for example, the user-related data from the first data provider identifying the person as a male between the ages of twenty and thirty with the user-related data from the second data provider indicating that the person recently consulted a consumer reporting web site regarding a particular model of a consumer electronics device. This allows the data buyers to request queries to be performed on the combined user-related data from the multiple data providers.

In some implementations, the access control module 204 stores the user-related data 210 in the data storage 208. Alternatively, the user-related data 210 can be stored individually at respective client computing devices and not stored in the data storage 208. However, the data storage 208 can include a mapping of identifiers of a person for different data providers. In addition, the access control module 204 can verify that the set of user-related data from each data provider includes a minimum number of unique identifiers before making the set of user-related data available to data buyers. For example, the minimum can be one hundred or one thousand different identifiers. In some implementations, a sufficiently large minimum number of identifiers can prevent the discovery of the actual identities of the persons represented by the set of user-related data.

The access control module 204 can generate the first identifier, the second identifier, and the internally maintained identifier so that they are different from one another. In some implementations, maintaining different identifiers for a person that are then provided to different data providers can prevent the data providers from sharing data about a person outside of the data exchange system 200.

In some implementations, a data provider can set terms for sharing user-related data provided by the data provider. The access control module 204 manages and enforces the terms. The access control module 204 ensures that access to the user-related data is provided in accordance with terms and restrictions specified by the data providers that own the user-related data. For example, in a subscription model, the access control module 204 can verify that conditions such as a length of time that the data is shared and a number of uses of the data have not expired before allowing a data buyer to access the data.

The terms can specify, for example, one or more data consumers (e.g., buyers) with which the data exchange system 200 is allowed to share the user-related data (e.g., a data buyer white list). In another example, the terms can specify one or more data buyers with which the data exchange system 200 is not allowed to share the user-related data (e.g., a data buyer black list).

The access control module 204 can allow a data provider to specify how the data exchange system 200 is allowed to share data. For example, the data provider may require that user-related data from the data provider only be used for targeting advertisements. In another example, the data provider can specify that the user-related data be used for analyzing a composition of the users that visit a website of the data provider without using the user-related data for targeting advertisements. The data provider can specify that the user-related data can be queried (e.g., as targeting criteria for an advertisement), but that the set of user-related data, which can include one or more data values other than the data value that satisfied the criteria, as a whole cannot be transferred to a data buyer.

In another example of data sharing terms, the access control module 204 can allow a data provider to specify one or more filtering criteria to be applied to the shared user-related data. For example, a data provider may choose to individually sell subscriptions to user-related data for various geographic regions. The data provider can specify a particular region as a term of the data sharing arrangement with the data buyer or the data provider can require that the data buyer specify a particular region for the data sharing arrangement. The access control module 204 then applies the filtering criteria as data is shared with data buyers. In some implementations, the access control module 204 applies the filtering criteria to user-related data that originates from the data provider itself. Alternatively or in addition, the access control module 204 can apply the filtering criteria to user-related data that originates from another source, such as user-related data that is joined with the user-related data from the data provider. The other user-related data can originate from, for example, another data provider or the data exchange system 200.

In yet another example, the terms can specify whether a data buyer can modify the user-related data and/or share the user-related data with one or more other data buyers. This allows a data buyer to syndicate data access to one or more other data buyers. The access control module 204 can then apply the terms and restrictions from the initial data provider to the first data buyer and also to the other data buyers that receive the syndicated aggregate data. For example, a data buyer can aggregate data purchased from a data provider with its own data and then syndicate the aggregated data to one or more other data buyers. In some implementations, a data provider choosing to allow syndication of its data can specify whether the syndicated data can be modified by a syndicating data buyer or if the data must be syndicated in its original form. The access control module 204 can allow the data provider to revoke syndication permission. The access control module 204 can apply the revocation to the first data buyer and the other data buyers that receive the syndicated aggregate data. Other forms of terms are possible including other forms of restrictions on the use of the data by a data subscriber.

Terms can also include exclusivity of access to a certain user-related data or set of user-related data. For example, a data buyer can buy exclusive rights to a set of user-related data from a particular data provider so that other data buyers are not allowed to purchase the exclusive user-related data. In another example, access to a certain user-related data or set of user-related data can be limited to a particular number of data buyers. In addition or alternatively, access to user-related data can be limited to a particular time period, such as a number of hours, days, or months. In addition or alternatively, access to user-related data can be limited to a particular number of uses. For example, a data provider may purchase rights to access the user-related data a particular number of times (e.g., one thousand data access instances) or in conjunction with a particular number of advertisement impressions (e.g., whether or not the advertisement impressions are actually awarded to the data buyer).

Terms can also include a trial or testing period where the data buyer is allowed to make use of the user-related data for a reduced fee or without being charged for that use. For example, a data provider can allow a data buyer to access user-related data to test the effectiveness of the user-related data. A data buyer is typically interested in how user-related data effects the conversion rates (e.g., how often a person clicks on or performs some other action as a result of being presented with an advertisement) of advertisements placed as a result of the access to the user-related data. For example, if access to the user-related data increases the conversion rate of an advertisement as compared to impressions of the advertisement that do not make use of the user-related data, then the data buyer may be more inclined to subscribe to the user-related data. In some implementations, the trial is limited to a particular amount of time. In some implementations, the trial is limited to a particular number of data accesses or a particular number of advertisement impressions.

In some implementations, a data provider can specify pricing for the user-related data provided by the data provider. Alternatively, the data exchange system 200 can determine the pricing for the user-related data. For example, the data exchange system 200 can include a data pricing module 212. The data pricing module 212 receives one or more offers 214 from data buyers wishing to buy access to user-related data. The data pricing module 212 uses pricing terms specified by the data providers and/or pricing terms defined by the data exchange system 200 to satisfy the offers 214.

In some implementations, the data pricing module 212 debits the data buyer by a fixed amount for the access to user-related data. The fixed amount can be for bulk access to a set of user-related data from a particular data provider for a group of multiple persons. In some implementations, the set of data can be referred to as a user list. Alternatively, the fixed amount can be for access to user-related data from a particular data provider for one person or for one pixel. In some implementations, the data pricing module 212 debits the data buyer by a fixed amount each time the data buyer accesses the user-related data. Alternatively, the data pricing module 212 can debit the data buyer once for multiple accesses of the user-related data over period of time, such as a number of days, weeks, or months. For example, a data buyer can pay a one time subscription fee to receive access to the user-related data or a set of user-related data. In some implementations, the subscription is limited to a particular number of accesses, a particular duration, and/or a particular number of advertisement impressions. The fixed amounts can be agreed upon between the data exchange system 200 and the data buyers, and the fixed amounts can be included in the offers 214.

In some implementations, the data pricing module 212 decreases the amount debited to a data buyer as the age of the user-related data increases. Some user-related data can decrease in value faster than other user-related data. For example, personal preferences and/or demographic information may remain relatively constant over time and retain their value while web page views and web page clicks may be time sensitive and decrease in value quickly. A person shopping for a car may have a sharp increase in visits to web pages related to cars and car buying. At some point, the person will, for example, buy a particular car or decide to not buy a car. The time during which the person is continuing to shop for a car can be more valuable than the time after the person stops shopping. The data pricing module 212 can, for example, reduce the amount debited to the data buyer once the car buying user-related data reaches a particular age, such as a number of minutes, hours, or days. In another example, the data pricing module 212 can reduce the amount debited to data buyers for the car user-related data multiple times over the course of the time interval. In yet another example, the data pricing module 212 can switch from a per access pricing model to a bulk access model after a set of user-related data reaches a particular age.

In some implementations, the data pricing module 212 decreases the amount debited to the data buyer as the number of times that the user-related data has been accessed by data buyers increases. For example, the car buying user-related data may decrease in value after having been provided to multiple data buyers and subsequently used to target car sales advertisements to the person shopping for a car. The data pricing module 212 can decrease the amount debited to subsequent data buyers that access the car buying user-related data. For example, the data pricing module 212 can decrease the amount debited each time the user-related data is accessed or at threshold numbers of accesses, such as one hundred accesses or one thousand accesses. While the car buying user-related data may decrease as its number of accesses increases, other user-related data, such as the preference and demographic data, may remain constant or decrease at a slower rate than the car buying user-related data.

In another example of pricing, the data pricing module 212 can auction the user-related data or one or more portions of user-related data 216 to one or more of the data buyers. The data buyers provide bids for the user-related data in the offers 214. In some implementations, the auction is performed in response to a request for an impression of an advertisement in a slot on a web page or in other online media. One or more of the data buyers can specify criteria for user-related data associated with an available advertisement slot in addition to an amount the data buyer is bidding for access to query the user-related data. The highest bidder or a highest number of bidders whose criteria are satisfied by the user-related data associated with the available advertisement slot can then proceed to an auction for the advertisement impression, as well as other advertisement auction bidders who did not specify criteria or do not require that the criteria be satisfied. The winning bid or bids for the advertisement slot then pay an agreed upon amount for the access to the user-related data, such as the next highest bid below the winner's bid. Alternatively, non-winning bids for the advertisement slot can also be charged for the access to the user-related data (e.g., the data provider is then not penalized for a low bid by the data buyer per se). This process of charging the non-winning bidders can be beneficial, in some implementations, where data is actually provided to the data buyer and there is a risk of the data buyer stealing data (e.g., subsequently using the data against the terms of the data sharing agreement).

In some implementations, the data pricing module 212 credits a portion of the amount paid by the data buyer to the data exchange and credits the remainder to the data provider. For example, the data pricing module 212 can credit a percentage of the amount paid by the data buyer to the data exchange or a fixed amount to the data exchange. In another example, the data pricing module 212 can credit the data exchange with a combination of a fixed amount and a percentage of the amount paid by the data buyer. In yet another example, the data pricing module 212 credits the data exchange with a percentage of the amount paid by the data buyer up to a maximum amount.

Where multiple data providers contribute to user-related data accessed by a data buyer, the data pricing module 212 can credit one or more of the contributing data providers. For example, the data pricing module 212 can divide the remainder of the amount paid by the data buyer evenly among the contributing data providers.

In another example, the data pricing module 212 can divide the remainder of the amount paid by the data buyer among the contributing data providers according to one or more factors. One example of a factor is the reach of the particular data provided. That is, the amount credited to a data provider can be based on the number of persons represented by the user-related data from the data provider, with data for a greater number of persons receiving a greater share of the credit than data for a smaller number of persons.

In another example, only the data providers that actually satisfy a condition in criteria set by the data buyer are credited. For example, the criteria may request data for those persons who are either male or in the market for a new car. A particular joined set of user-related data may only satisfies the male criteria and not the new car condition. As a result, a data provider sharing the male data is credited for sharing the user-related data that indicates the person is male while another data provider that shares car market data is not credited because the car market data does not indicate that the person is in the market for a new car.

In some implementations, the data exchange system 200 does not provide the user-related data to the data buyer. For example, the data exchange system 200 can use the user-related data to determine if an available advertisement slot meets criteria set by the data buyer without actually providing the user-related data to the data buyer.

The data exchange system 200 can include an advertisement selection module 218. The advertisement selection module 218 receives one or more offers 220 from advertiser systems for placement of an advertisement in an available advertisement slot. One or more of the data buyers can also be advertisers that provide offers for the slot. The offers 220 can include an indication of a fixed monetary amount to be paid by the advertiser. The fixed amount can be set by the advertiser, by the publisher that provides the advertisement slot, by the data exchange system 200, or another system that provides advertisement serving. Alternatively, the advertisers can compete in an advertisement slot auction. The advertisement selection module 218 can receive the offers 220 which include bids from the advertisers for an advertisement placement in the available advertisement slot. The advertisement selection module 218 selects an offer from the advertisers and outputs an advertisement 222 associated with the selected offer for presentation at a client computing device of the person associated with the user-related data. In some implementations, the data exchange system 200 or an advertisement serving system store the advertisement 222 in an advertisement storage 224 prior to performing the selection of the offer from the advertisers.

In some implementations, the advertisement selection module 218 and/or the advertisement storage 224 are included in a system that is separate from the data exchange system 200. The advertisement selection module 218 can then communicate with components of the data exchange system 200 or an intermediate system. For example, the advertisement selection module 218 can inform the data pricing module 212 of an amount paid by a data buyer for an advertisement presented to a user. The data pricing module 212 can then use the amount to determine a compensation for the data provider that supplied the data related to the user that was presented with the advertisement.

In some implementations, the data buyers are not debited unless they subsequently receive an advertisement placement in an available advertisement slot. A portion of the amount paid for the advertisement placement by the advertiser/data buyer is then credited to the one or more data providers that provided the user-related data accessed by the advertiser/data buyer. For example, the portion paid to the data provider can be a percentage of the amount paid by the advertiser/data buyer or a fixed portion. Alternatively, data buyers can be debited whether they receive an advertisement placement or not.

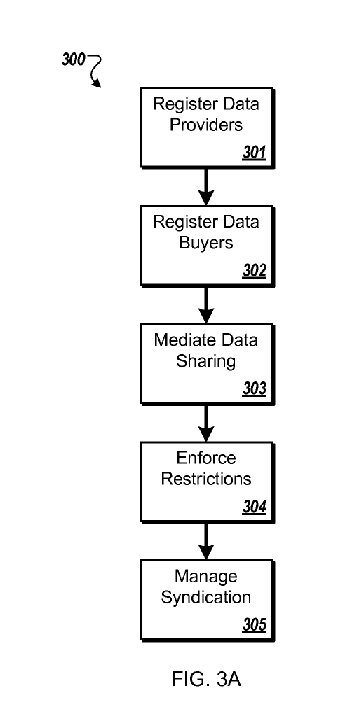

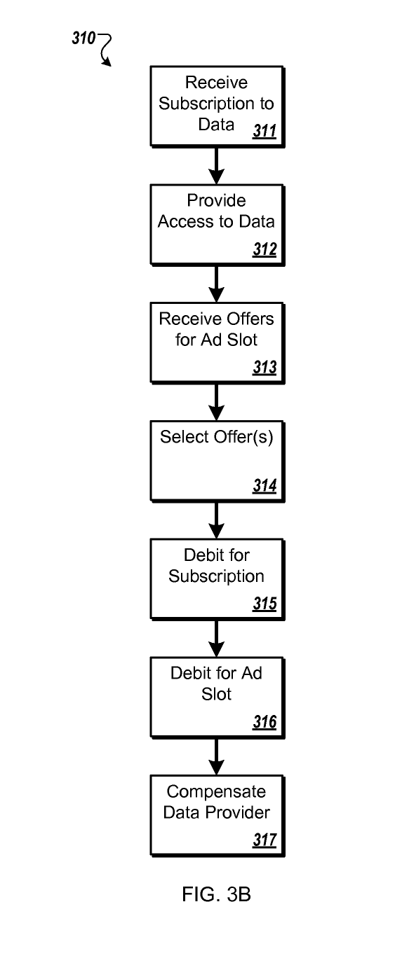

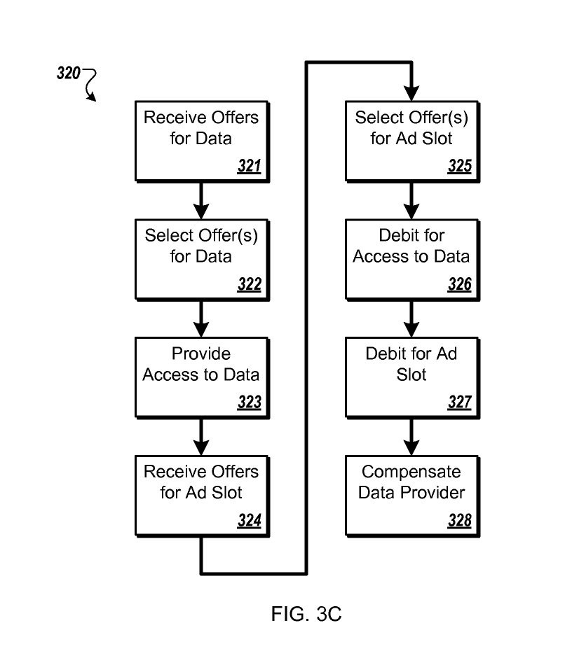

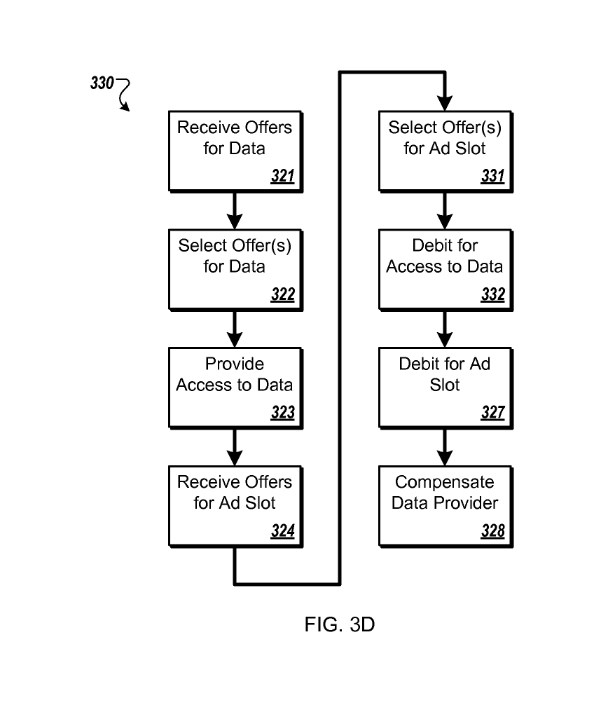

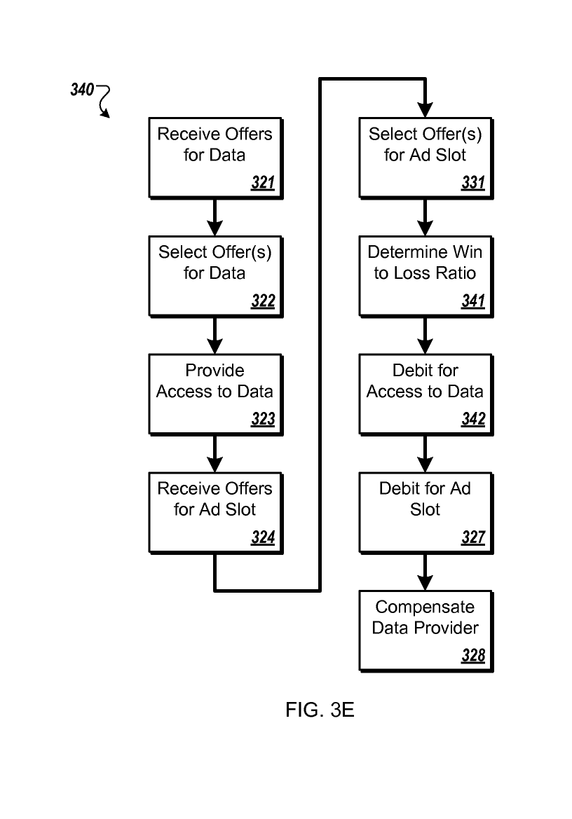

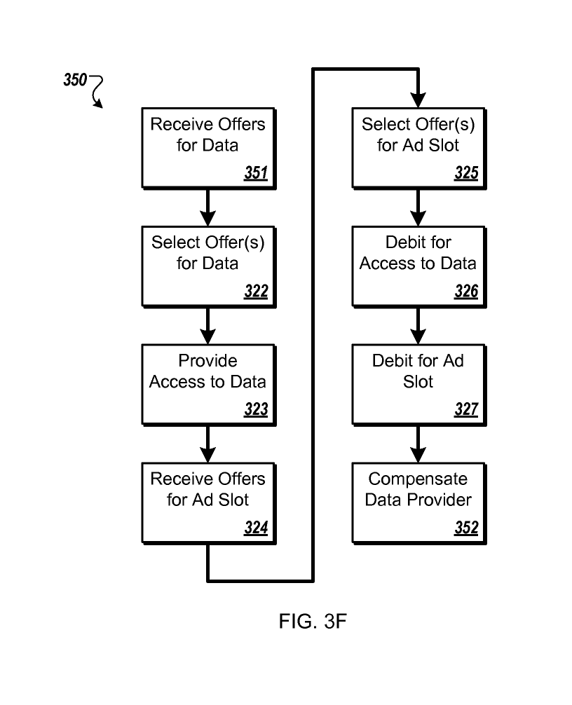

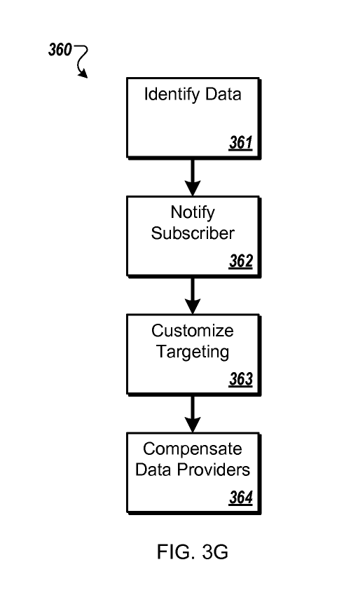

FIGS. 3A-G and 4A-E are flow charts that show examples of processes for controlling access to and pricing user-related data. The processes may be performed, for example, by a system such as the system 100 and the data exchange system 200. For clarity of presentation, the description that follows uses the system 100 and the data exchange system 200 as examples for describing the processes. However, another system, or combination of systems, may be used to perform the processes.

Referring to FIG. 3A, a process 300 for controlling access to user-related data begins with electronically registering (301) a plurality of data providers with a computer-implemented data exchange. For example, the data provider systems 106a-c can register with the data exchange system 102 using a web interface or an application program interface provided by the data exchange system 102. In some implementations, registration can include providing identification or financial account information for a data provider. Registration can also include information describing the content of the user-related data (e.g., metadata), the number persons represented by the set of user-related data, and/or identifiers for each portion of the set representing a person. Registration can also include specifying a price or minimum bid to be paid by a data buyer for a subscription to the set and/or access to user-related data for an individual person.

The process 300 also includes electronically registering (302) a plurality of data buyers with the computer-implemented data exchange. For example, the advertiser systems 110a-c can register with the data exchange system 102 using a web interface provided by the data exchange system 102. Registration can include, for example, providing identification and/or financial account information for an advertiser. Registration can also include providing an amount to be offered or bid for access to the user-related data. For example, an advertiser can provide a standing offer to buy data at a particular price. The standing offer can be restricted by a cap so that the amount spent purchasing data over a particular period of time does not exceed the cap.

The process 300 then mediates (303) a data sharing arrangement between one or more of the data buyers and one or more of the data providers. The data sharing arrangement defines prices and permitted uses of data provided by the one or more data providers to the one or more data buyers. For example, the data pricing module 212 can determine a price for data access, such as a winning bid.

The process 300 enforces (304), on behalf of the one or more data providers, one or more restrictions imposed by the data sharing arrangement on the one or more data buyers. For example, the restrictions can include one or more of (a) limiting the data sharing arrangement to a particular number of data buyers, (b) limiting the data sharing arrangement to a particular amount of time, (c) preventing specific data buyers from accessing the data, (d) allowing specific data buyers to access the data, (e) verifying that the data includes information for at least a minimum number of users, (f) limiting the data to use in bidding for an advertisement placement, (g) one or more filtering criteria, and (h) limiting a number of advertisement impressions from one or more of the data buyers for the portion of the data. In some implementations, the access control module 204 can enforce the restrictions.

The process 300 manages (305) syndication permissions for the one or more data buyers to share the data. Managing the syndication permissions can include permitting the one or more data buyers to share the data in its original form. Managing the syndication permissions can include permitting the one or more data buyers to aggregate the data with additional data. Managing the syndication permissions can include revoking the syndication permissions. The process 300 can include determining one or more additional data buyers with which the data has been shared, and managing the syndication permissions can include applying the syndication permissions to the additional data buyers. For example, the access control module 204 can perform steps to manage syndication permissions.

The process 300 can include providing lists of identifiers to each of the plurality of data providers. The process 300 can include encrypting the identifiers in each of the lists. Alternatively, the data providers can provide identifiers to a data exchange system. For example, a data provider can include a pixel on a web page of the data provider that is directed to the data exchange system. A client computing device can download the web page from the data provider and process the pixel. The web page can include code or markup to pass the data provider's identifier (and optionally other information) for the user at the client computing device. The pixel can send the information to the data exchange system, which can either store the information in a cookie at the client device for the data exchange system's domain and/or the information can be stored on one or more servers at the data exchange system. In some implementations, the information is stored in the cookie at the client device without sending the information to the servers at the data exchange system.

The process 300 can include correlating data from a first one of the one or more data providers with a second one of the data providers using the encrypted identifiers from the lists for the first and second ones of the one or more data providers. Alternatively, the data providers can pass identifiers to a data exchange system and the data exchange system can match the passed identifiers with its own identifiers to correlate different data from the data providers with a user.

The computer-implemented data exchange can collect data for at least one of the one or more data providers. At least one of the one or more data providers can collect a portion the data. The process 300 can include providing a portion of the data to the one or more data buyers during purchases of advertisement placements. The process 300 can also include receiving an indication of one or more logical operations from the one or more data buyers that filter the data. For example, a data buyer can perform a query on key and value pairs in the data to identify data for certain users matching the key and value pair in the query.

Referring to FIG. 3B, a process 310 for pricing subscribed user-related data begins with receiving (311), from an advertiser, a subscription to a set of data related to multiple persons. The set of data includes data related to a person, and the set of data is provided by a data provider. For example, the advertiser system 110a can use the data exchange system 102 to subscribe to the user-related data from the data provider system 106a.

The process 310 then provides (312) access to the set of data to the advertiser. For example, the data exchange system 102 can allow the advertiser system 110a to use the data to target advertisement placements or to perform an analysis of the data, such as by aggregating particular values together (e.g., without actually transferring the data to the advertiser system 110a). In another example, the data exchange system 102 can transfer data to the advertiser system 110a.

The process 310 receives (313) offers for an advertisement slot from the advertiser and other advertisers. The advertisement slot is associated with the data related to the person. For example, the advertiser system 110a and the advertiser systems 110b-c can place bids for the advertisement slot.

The process 310 then selects (314) at least one of the offers for the advertisement slot. For example, the advertisement selection module 218 can perform an auction using the bids from the advertisers.

The process 310 debits (315) the advertiser that has the subscription for the set of data. For example, the data pricing module 212 can charge a subscribing advertiser system a one time fee and then subsequently allow the advertiser system to access the data repeatedly (e.g., for a period of time or for a number of uses). Alternatively or in addition, the data pricing module 212 can charge a per use fee for the subscription to the data.

The process 310 also debits (316) an advertiser that has the selected offer for the advertisement slot. For example, the advertisement selection module 218 can debit the advertiser system or systems that have winning bids for the advertisement slot.

The process 310 compensates (317) the data provider for the set of data. For example, the compensation can be a portion of the amount paid by the advertisers for the data and/or the advertisement slot.

Referring to FIG. 3C, a process 320 for pricing offers for user-related data begins with receiving (321) first offers from advertisers for data related to a person. The data is a member of a set of data related to multiple persons, and the set of data is provided by a data provider. In some implementations, the data related to the person does not include information capable of determining an identity of the person. For example, the data exchange system 102 can receive offers that include bids for data in an auction or offers for a fixed rate data sharing agreement.

The process 320 then selects (322) one or more of the first offers for the data. For example, the data pricing module 212 can determine one or more winning bids in the data auction or select offers for fixed rate data sharing.

The process 320 provides (323) access to the data to the advertisers having the selected first offers. For example, the access can include transferring raw and/or aggregated data to the data buyer. In another example, the access can include using the data at the data exchange system 102 to target bids for advertisements.

The process 320 receives (324) second offers for an advertisement slot from at least the advertisers having the selected first offers. The advertisement slot is associated with the data related to the person. For example, the advertiser systems 110a-c can place bids for one or more advertisement slots based on user-related data for a person to be presented with advertisements in the slots.

The process 320 then selects (325) at least one of the second offers for the advertisement slot. The process 320 can also include receiving an advertisement from the advertiser and, as a result of selecting the second offer, outputting the advertisement for presentation in the advertisement slot. For example, the advertisement selection module 218 can select one or more winning bids and provide corresponding advertisements from the advertisement storage 224 to the client computing system of the person.

The process 320 debits (326) the advertisers having the selected first offers for the data. Debiting the advertisers having the selected first offers for the data can include debiting the advertisers having the selected first offers based on one or more criteria. The criteria can include a win to loss ratio of offers from the advertisers for advertisement slots. For example, the data pricing module 212 can debit the advertisers by corresponding amounts determined during an auction for the data, by a fixed amount, or by a portion of an amount paid for advertisement slots provided in conjunction with the data access.

The process 320 also debits (327) an advertiser having the selected second offer for the advertisement slot. For example, the advertisement selection module 218 can debit the advertisers that have the winning bids in the advertisement slot auction.

The process 320 compensates (328) the data provider for the data. For example, compensating the data provider can include compensating the data provider as a percentage of one of the second offers for the advertisement slot. Compensating the data provider can include compensating the data provider in proportion to a reach of the data provided. Compensating the data provider can include compensating the data provider in proportion to performance of the data provided. Compensating the data provider can include compensating the data provider based on a number of times that the data has been provided. Compensating the data provider can include compensating the data provider based on an age of the data provided. In some implementations, the data pricing module 212 can perform the determination of the compensation for the data provider.

The process 320 can include determining that a portion of the data provided by the data provider satisfies a criteria specified by at least one of the advertisers. The process 320 can include receiving an offer cap from at least one of the advertisers that sets a limit on a total amount to be spent by the at least one of the advertisers on offers for data, and not selecting the first offer from the at least one of the advertisers as a result of the first offer from the at least one of the advertisers taking the total amount to be spent over the offer cap for the at least one of the advertisers.

Referring to FIG. 3D, a process 330 for pricing offers for user-related data includes steps that are similar to the steps in the process 320 of FIG. 3C. The process 330 selects (331) at least one of the second offers for the advertisement slot. However, the selected second offer is not from at least one of the advertisers having the selected first offers. For example, the data exchange system 102 may provide the advertiser system 110a with access to the user-related data from the data provider system 106a, but the advertiser system 110a may lose a subsequent auction for advertisement placements to the person or client computing device associated with the user-related data.

In addition, the process 330 debits (332) the advertisers having the selected first offers for the data, including debiting the advertiser whose second offer was not selected. For example, the data pricing module 212 may charge a data access fee (e.g., a bid amount or a fixed fee) to the advertiser system 110a even though the advertiser system 110a did not win or was not provided with an advertisement slot.

Referring to FIG. 3E, a process 340 for pricing offers for user-related data includes steps that are similar to the steps in the process 320 of FIG. 3C and the process 330 of FIG. 3D. However, the process 340 also includes determining (341) win to loss ratios for the advertisers having the selected first offers. For example, the data pricing module 212 and/or the advertisement selection module 218 can determine a win to lose ratio for an advertiser. The win to lose ratio may be for wins and losses in a data access auction or an advertisement placement auction. The wins and losses can be for a particular period or time, such as a number of days, months, or years.

The process 340 then debits (342) one or more of the advertisers having win to loss ratios that exceed a threshold value. For example, if the win to loss ration for an advertiser is greater than the threshold for the advertiser (e.g., the advertiser has a minimum percentage of wins), then the data pricing module 212 debits the advertiser. In some implementations, the data pricing module 212 can perform the debit even if the advertiser lost the current data and/or advertisement auction.

Referring to FIG. 3F, a process 350 for pricing offers for user-related data includes steps that are similar to the steps in the process 320 of FIG. 3C. Like the process 320, the process 350 includes receiving (351) first offers from advertisers for data related to a person and the data is a member of a set of data related to multiple persons. However, in the process 350, a plurality of portions of the data are provided by a corresponding plurality of data providers. For example, the data exchange system 102 can receive offers from the advertiser systems 110a-c for the user-related data from the data provider systems 106a-c.

In addition, the process 350 includes compensating (352) one or more of the data providers for the data. For example, compensating the one or more of the data providers can include compensating each data provider as a percentage of one of the second offers for the advertisement slot. Compensating the one or more of the data providers can include compensating each data provider in proportion to a reach of the portion provided by the data provider. Compensating the one or more of the data providers can include compensating each data provider in proportion to a performance of the portion provided by the data provider. Compensating the one or more of the data providers can include compensating each data provider evenly. Compensating the one or more of the data providers can include compensating each data provider based on a number of times that the portion has been provided by the data provider. Compensating the one or more of the data providers can include compensating each data provider based on an age of the portion provided by the data provider. Compensating the one or more of the data providers can include compensating fewer than all of the data providers. For example, the data pricing module 212 can determine the amounts by which the data providers are compensated.

The process 350 can include determining for each data provider that the portion provided by the data provider satisfies one or more criteria for inclusion in the data. The process 350 can also include determining that one or more other data providers having provided other data related to the person do not satisfy the criteria for inclusion in the data. As a result, compensating the one or more of the data providers can include compensating the data providers that provided the portions that satisfy the criteria. In some implementations, each data provider can have an associated priority, and the process 350 can include selecting the data providers based on the priorities. The priorities can be based on a performance of the portions provided by the data providers.

Referring to FIG. 3G, a process 360 for pricing a subscription for user-related data begins with identifying (361) user-related data associated with a person. The user-related data is provided by at least two different sources. For example, the data exchange system 102 can identify data related to a person or a client computing device. Portions of the data can be provided by multiple data provider systems. Portions of the data can also be provided by the data exchange system 102 itself as well as an advertisement auction/placement system. The data exchange system 102 can joint the data from multiple sources into sets of data, where each set of data is associated with a particular person or client computing device.

The process 360 notifies (362) a subscriber to the user-related data that a request for content has been received from the person associated with the user-related data. For example, the data exchange system 102 can notify the advertiser system 110a that a request has been received from the client computing device 114a for content from the publisher system 118a. The notification can include user-related data associated with the client computing device 114a and/or a particular person operating the client computing device 114a.

The process 360 customizes (363) targeting to the person based on the user-related data. For example, the data exchange system 102 can allow the advertiser system 110a to specify instructions for placing one type of advertisement for data having a first data value and a second type of advertisement for data having a second data value. Alternatively or in addition, the data exchange system 102 can allow the advertiser system 110a to specify instructions for placing a first bid at a first amount for data having a first data value and a second bid at a second amount for data having a second data value.

The process 360 compensates (364) each of the two different sources according to a formula based on a value of a portion of the user-related data provided by a respective source. For example, compensating each of the two different sources can include compensating each source in proportion to a reach of the portion provided by the respective source. Compensating each of the two different sources can include compensating each source in proportion to a performance of the portion provided by the respective source. Compensating each of the two different sources can include compensating each source evenly. Compensating each of the two different sources can include compensating each source based on a number of times that the portion has been provided by the respective source. Compensating each of the two different sources can include compensating each source based on an age of the portion provided by the respective source. For example, the data pricing module 212 can determine the compensation for each of the data provider systems 106a-c.

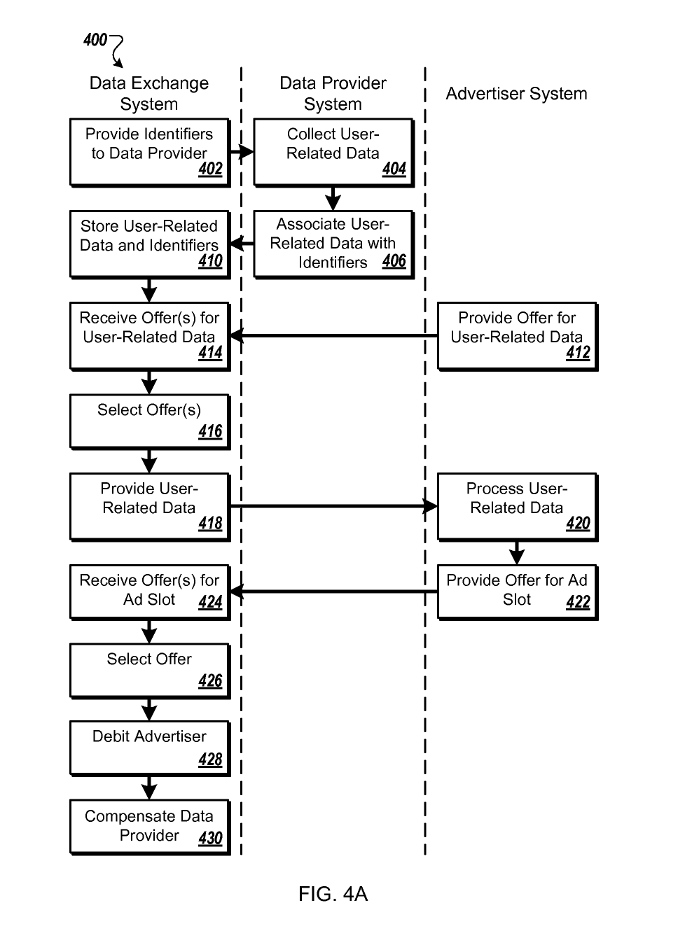

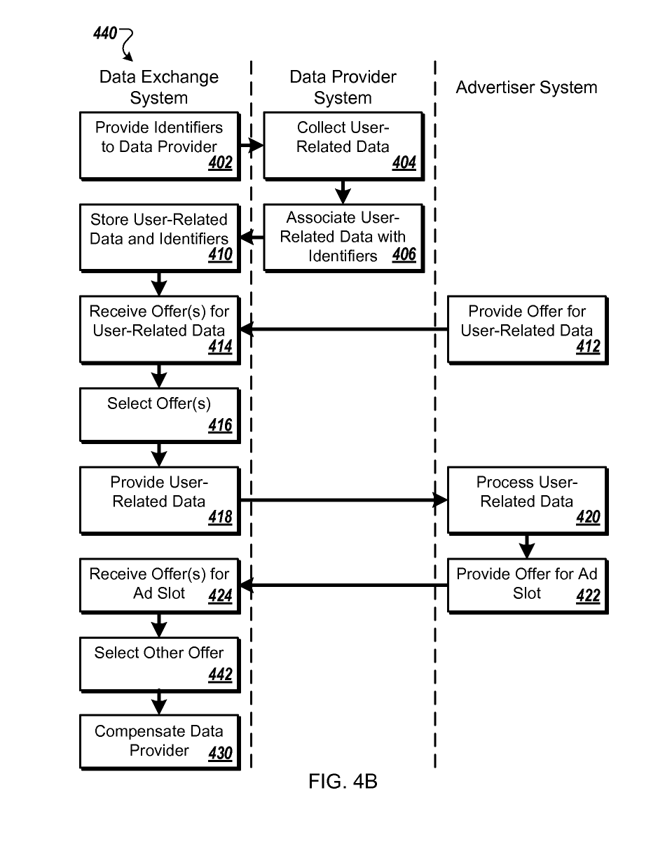

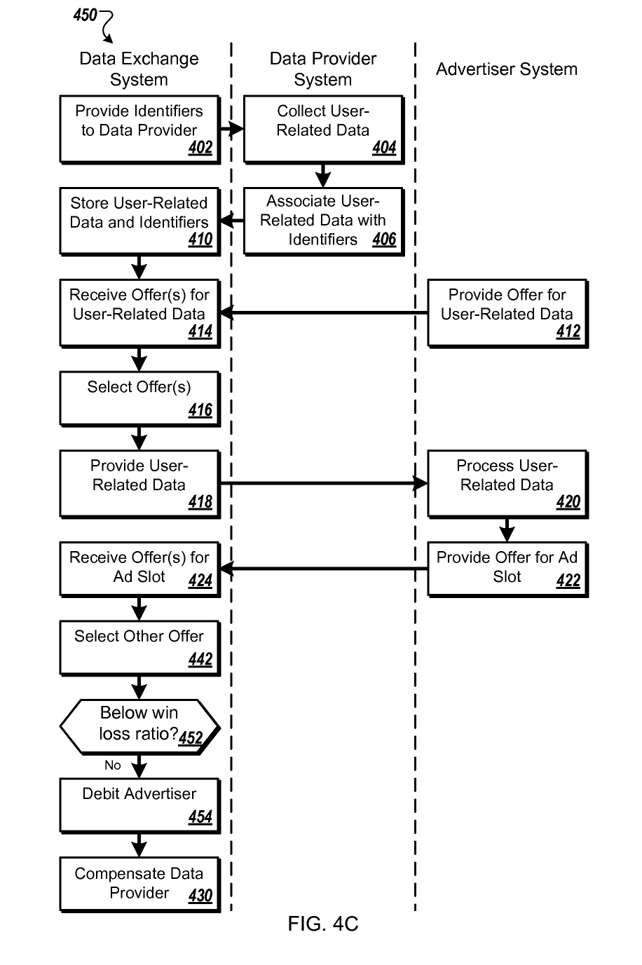

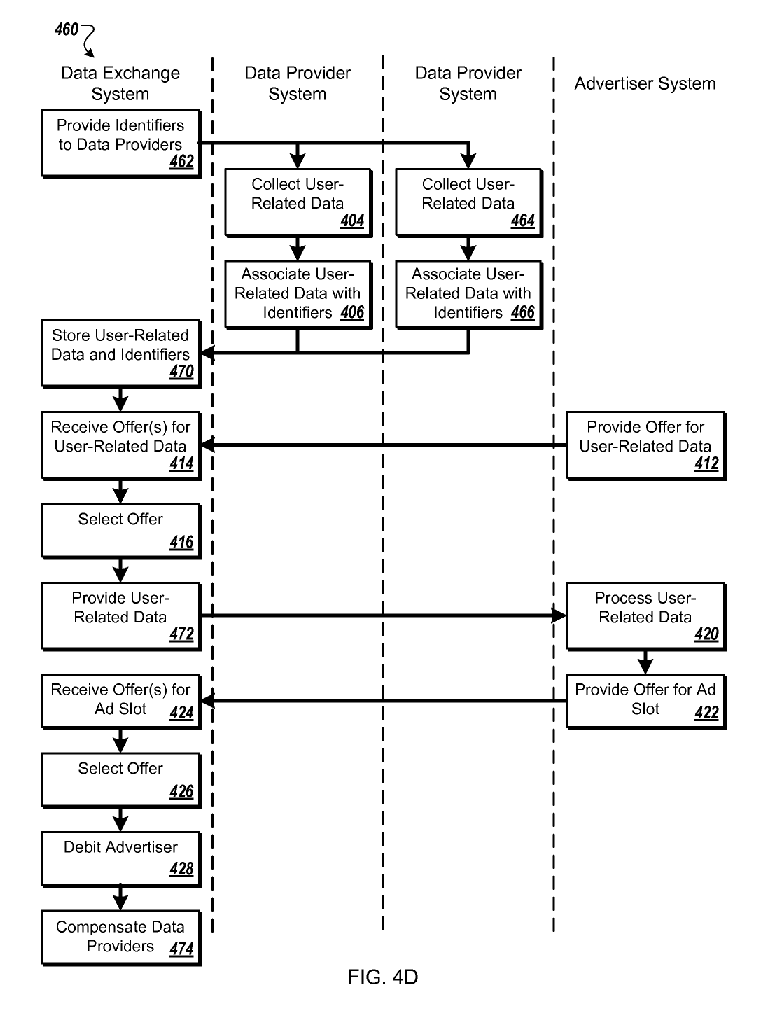

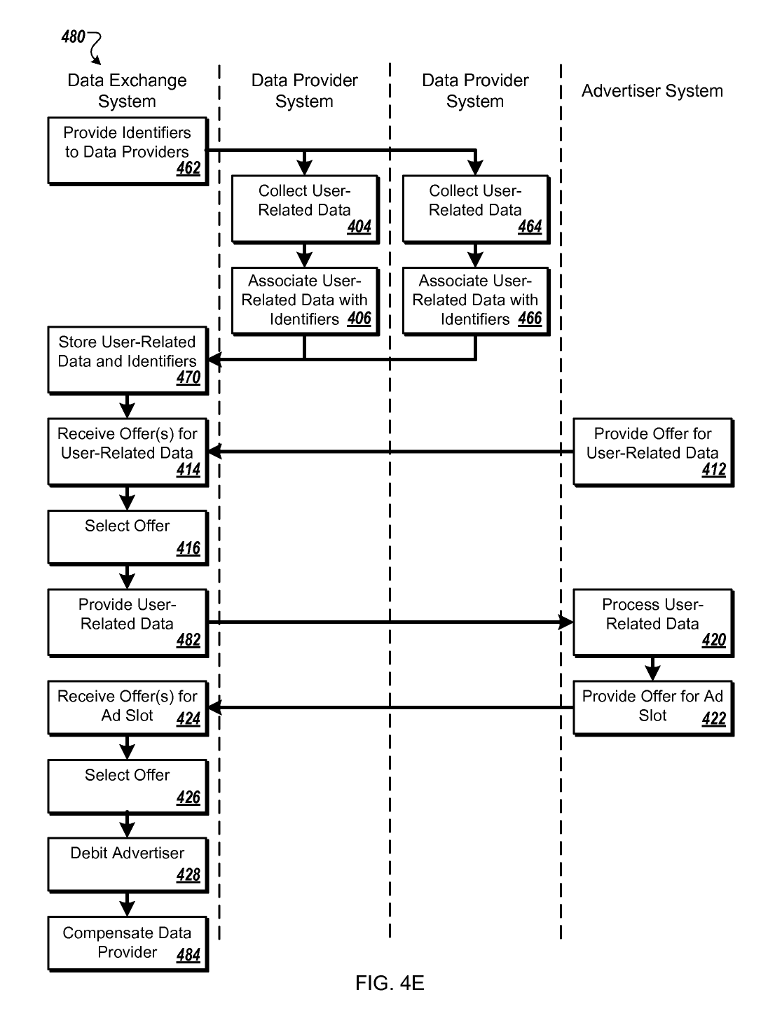

Referring to FIG. 4A, a process 400 for pricing data from a single data provider begins by providing (402) one or more identifiers to the data provider. For example, the data exchange system 102 can provide encrypted and/or unique identifiers to the data provider system 106a.

User-related data is collected (404) for one or more persons. For example, the data provider system 106a collects online data that persons at the client computing devices 114a-c submit to the data provider system 106a through the network 108. In another example, offline user-related data can be entered into the data provider system 106a.

The collected user-related data is associated (406) with the persons (e.g., using the corresponding ones of the identifiers received from the data exchange system). The data provider can provide the user-related data and the corresponding identifiers to the data exchange system. For example, the data provider system 106a can store the user-related data received from the client computing devices 114a-c and perform a bulk transfer to the data exchange system. In another example, the data provider system 106a can store the user-related data in cookies at the client computing devices 114a-c. The data provider system 106a can then provide the user-related data from a cookie at a client computing device to the data exchange system 102 along with a request for content (e.g., an ad request) or in response to a request for the user-related data or as a broadcast message to the data exchange system 102. In yet another example, the data exchange system 102 can receive the user-related data from a data provider system as parameters in a URL of an inline frame.

In some implementations, the user-related data is stored (410). For example, the data exchange system 200 can store the user-related data 210 in the data storage 208. In another example, the data exchange system 102 can store the user-related data in cookies at the client computing devices 114a-c. The cookies can be accessible by the Internet domain used by the data exchange system 102. The steps of collecting, associating, and storing the user-related data can be repeated one or more times prior to continuing with the process 400.

One or more offers are received (412, 414) for at least a portion of the user-related data. For example, the data exchange system 102 can receive offers from the advertiser systems 110a-c for the user-related data. One or more of the offers are selected (416) as recipients/subscribers of portions of the user-related data. For example, an offer can include a fixed fee or a bid in a user-related data auction process.

Access (418) is provided to the portion of the user-related data to at least the selected recipient/subscriber. In providing access, one or more terms and/or restrictions on the access of the user-related data can be enforced. In some implementations, access to the user-related data includes identification of an advertisement slot for placement of an advertisement (e.g., a request for one or more advertisements is received from a user's computing device, user lists associated with the user are identified and subscribers to the user list are notified of the request so that the subscriber can, for example bid or customize content provided in response to the request). Alternatively, access to the user-related data can include an actual transfer of the user-related data to the advertiser system.

The user-related data can be processed (420) as requests are received. For example, processing can include deciding whether or not to bid on an advertisement slot or how much to bid on an advertisement slot. In another example, processing can include analyzing a composition of a group of users that visits a website of the data provider. In addition, processing can include updating the user-related data itself, such as by recording what advertisement was shown to the person or which web page the person visited, for example.

An offer for an advertisement slot can be generated (422) based on a received request and processing of the user-related data. The process 400 includes receiving (424) the offer and can include receiving one or more other offers. For example, the data exchange system 102 can receive offers from multiple subscribers to the user-related data or to non-subscribers to the user-related data. An offer can include a fixed fee or a bid in an advertisement slot auction process.

One or more offers can be selected (426) as satisfying the request and an advertisement can be output from the winning advertiser for presentation in the advertisement slot. Accesses to the user-related data can incur debits (428) (e.g., to the advertiser that won and optionally to advertisers that used the user-related data and did not win) and compensation paid (430) (e.g., to the data provider). The debit to the advertiser can include the amount offered/required for access to the user-related data as well as the amount offered for the advertisement placement. The compensation to the data provider can include at least a portion of the amount paid by the advertiser for winning the slot. The data exchange system can also compensate the data exchange with a portion of the amount paid by the advertiser for the user-related data or the slot.

Referring to FIG. 4B, a process 440 for pricing data from a single data provider includes steps that are similar to the steps in the process 400 of FIG. 4A. However, in the process 440 the data exchange system instead selects (442) another advertiser to receive the advertisement placement rather than the advertiser that provided (422) the offer. In this example, the data exchange system does not debit the advertiser for the advertisement placement or the access to the user-related data.

Referring to FIG. 4C, a process 450 for pricing data from a single data provider also includes steps that are similar to the steps in the process 440 of FIG. 4B. However, in the process 450 a determination (452) is made whether criteria are satisfied for charging a non-winning advertiser. For example, the data exchange system 102 can determine if a win to loss ratio of the advertiser is below a particular threshold. Other criteria can be used. If the criteria are satisfied, the non-winning advertiser is debited (454) for accessing/using the user-related data. For example, if the threshold win to loss ratio is one half and the advertiser has won more than half of the advertisement slot auctions, then the data exchange system can proceed with debiting the advertiser for the access to the user-related data. In some implementations, the wins and losses can be recorded over a long period of time (e.g., a number of days, months, or years) and the win to loss ratio can be calculated or used at particular intervals. For example, the win to loss ratio can be calculated for each month or year and used for the subsequent month or year, respectively.

Referring to FIG. 4D, a process 460 for pricing data from multiple data providers includes steps that are similar to the steps in the process 400 of FIG. 4A. In the process 460, identifiers are provided (462) to a first data provider and at least a second data provider. The second data provider also collects user-related data (464), associates the user-related data with corresponding ones of the identifiers (466), and provides the user-related data and identifiers (e.g., to the data exchange system). The user-related data from the first and second data providers is stored (470). In response to the offer for user-related data, access is provided (472) to the user-related data from the first and second data providers (e.g., to subscribers to the respective user-lists). In providing access, one or more terms and/or restrictions on the access of the user-related data can be enforced.

As a result of the combined contributions of the first and second data providers, compensation can be paid (474) to both of the first and second data providers for the access to the user-related data. For example, both data providers can be compensated evenly. In another example, each of the data providers can be compensated based on a reach or number of persons represented by a respective set of user-related data provided by the data provider. In another example, each of the data providers can be compensated based on a performance of the set of user-related data provided by the data provider. Performance can include, for example, a likelihood that an advertisement placement associated with the user-related data will result in a conversion or other action by the person on the advertisement. The likelihood can be based on the frequency with which previous advertisement placements have resulted in a conversion.

Referring to FIG. 4E, a process 480 for pricing data from multiple data providers includes steps that are similar to the steps in the process 460 of FIG. 4D. In the process 480 fewer than all of the data providers are compensated (484). For example, if a user-related data criteria specified by the advertiser is met by the user-related data provided by the first data provider and not the user-related data provided by the second data provider, then the advertiser is not debited for the user-related data from the second data provider. The process 480 includes providing access (482) to the user-related data. In some examples, the data exchange system may only provide access to the user-related data from the first data provider. In another example, the data exchange may provide access to user-related data from both data providers. In some implementations, the data exchange system can use metadata associated with respective data providers to determine who will be compensated. For example, the data exchange system can compare priorities of the data providers to determine which data provider is to be compensated. In some implementations, the priorities of the data providers are based on the performance of the respective user-related data provided by the data providers. For example, a high conversion rate for a set of user-related data may correspond to a high priority.

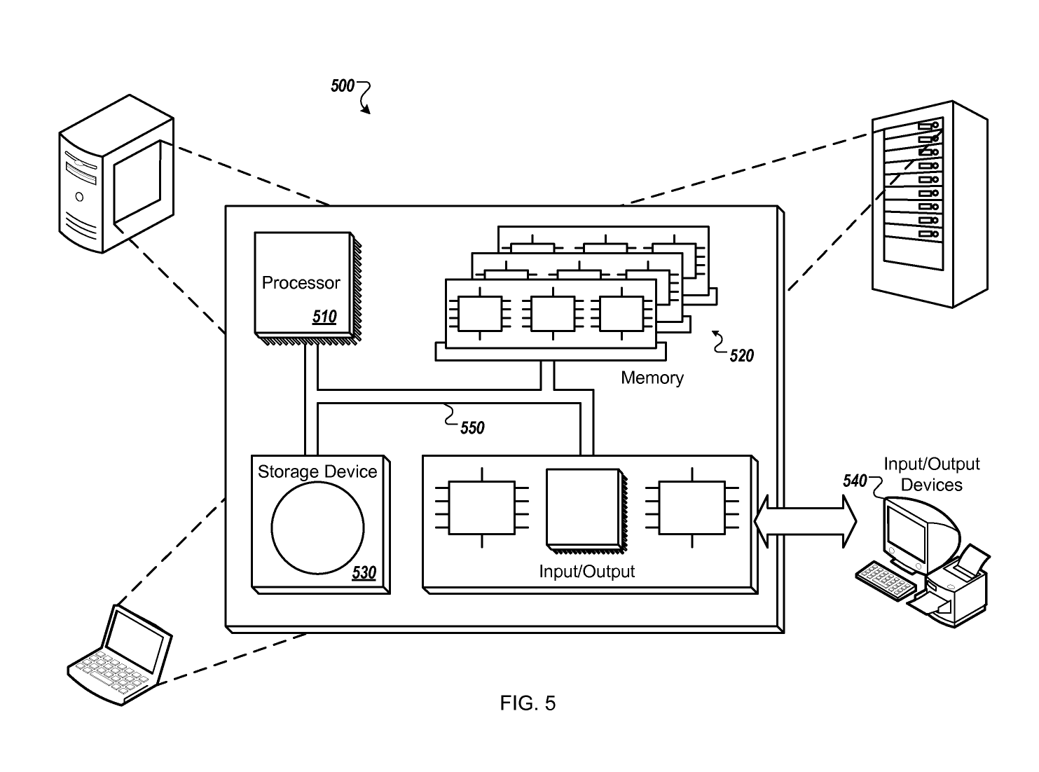

FIG. 5 is a schematic diagram that shows an example of a computing system 500. The computing system 500 can be used for some or all of the operations described previously, according to some implementations. The computing system 500 includes a processor 510, a memory 520, a storage device 530, and an input/output device 540. Each of the processor 510, the memory 520, the storage device 530, and the input/output device 540 are interconnected using a system bus 550. The processor 510 is capable of processing instructions for execution within the computing system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the computing system 500. In some implementations, the memory 520 is a computer-readable medium. In some implementations, the memory 520 is a volatile memory unit. In some implementations, the memory 520 is a non-volatile memory unit.

The storage device 530 is capable of providing mass storage for the computing system 500. In some implementations, the storage device 530 is a computer-readable medium. In various different implementations, the storage device 530 may be a floppy disk device, a hard disk device, an optical disk device, or a tape device.

The input/output device 540 provides input/output operations for the computing system 500. In some implementations, the input/output device 540 includes a keyboard and/or pointing device. In some implementations, the input/output device 540 includes a display unit for displaying graphical user interfaces.

Some features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, some features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Some features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for controlling access to user-related data, comprising:
electronically registering a plurality of data providers with a computer-implemented data exchange;
electronically registering a plurality of data buyers with the computer-implemented data exchange;
mediating a data sharing arrangement between one or more of the data buyers and one or more of the data providers, the data sharing arrangement defining prices and permitted uses of data provided by the one or more data providers to the one or more data buyers; and
enforcing, on behalf of the one or more data providers, one or more restrictions imposed by the data sharing arrangement on the one or more data buyers.

2. The method of claim 1, wherein the restrictions include limiting the data sharing arrangement to a particular number of data buyers.

3. The method of claim 1, wherein the restrictions include limiting the data sharing arrangement to a particular amount of time.

4. The method of claim 1, wherein the restrictions include preventing specific data buyers from accessing the data.

5. The method of claim 1, wherein the restrictions include allowing specific data buyers to access the data.

6. The method of claim 1, wherein the restrictions include verifying that the data includes information for at least a particular minimum number of users.

7. The method of claim 1, wherein the restrictions include limiting the data to use in bidding for an advertisement placement.

8. The method of claim 1, wherein the restrictions include one or more filtering criteria.

9. The method of claim 1, further comprising providing lists of identifiers to each of the plurality of data providers.

10. The method of claim 9, further comprising encrypting the identifiers in each of the lists.

11. The method of claim 10, further comprising correlating data from a first one of the one or more data providers with a second one of the data providers using the encrypted identifiers from the lists for the first and second ones of the one or more data providers.

12. The method of claim 1, wherein the computer-implemented data exchange collects data for at least one of the one or more data providers.

13. The method of claim 1, wherein at least one of the one or more data providers collect a portion the data.

14. The method of claim 1, further comprising providing a portion of the data to the one or more data buyers during purchases of advertisement placements.

15. The method of claim 14, wherein the restrictions include limiting a number of advertisement impressions from one or more of the data buyers for the portion of the data.

16. The method of claim 1, further comprising managing syndication permissions for the one or more data buyers to share the data.

17. The method of claim 16, wherein managing the syndication permissions comprises permitting the one or more data buyers to share the data in its original form.

18. The method of claim 16, wherein managing the syndication permissions comprises permitting the one or more data buyers to aggregate the data with additional data.

19. The method of claim 16, wherein managing the syndication permissions comprises revoking the syndication permissions.

20. The method of claim 16, further comprising determining one or more additional data buyers with which the data has been shared, and wherein managing the syndication permissions comprises applying the syndication permissions to the additional data buyers.

21. The method of claim 1, further comprising receiving an indication of one or more logical operations from the one or more data buyers that filter the data.
